(19) United States
(12) Patent Application Publication
(10) Pub. No.: US 2006/0029809 A1
(43) Pub. Date: Feb. 9, 2006

(54) Backmolded plastic moldings

(75) Inventors: Achim Grefenstein, Altrip (DE); Manfred Knoll, Wachenheim (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/234,285

(22) Filed: Sep. 26, 2005

Related U.S. Application Data
(63) Continuation of application No. 10/019,025, filed on Dec. 26, 2001.

(30) Foreign Application Priority Data
Jun. 23, 1999 (DE) 19928774.0

(51) Int. Cl. B32B 27/36; B32B 27/34; C08L 77/00; C08L 51/00

(52) U.S. Cl. 428/412; 525/66; 525/67; 525/70; 428/474.4; 428/480

(57) ABSTRACT

Described is a backmolded plastic molding comprising a polymer backmolding film backmolded by injection molding or casting with a fiber reinforced plastic having a fiber content of from 5 to 30%, the film having a thickness of from 0.5 to 1.0 mm and the backmolding material having a thickness of from 1.5 to 4.5 mm.

The invention relates to backmolded plastic moldings, to processes for their production, and to their use as or in motor vehicle exterior bodywork parts.

When plastics are used outdoors where they are subject to weathering and, in particular, UV radiation, high standards are required in terms of UV stability and weathering stability. Especially when they are used in exterior bodywork parts in the automotive sector, stringent requirements are also set for other mechanical properties, such as the low-temperature impact strength, as well as for the optical quality. The processes and materials employed at present do not always meet these conditions.

Bodywork parts made from plastics are, for example, topcoated or mass-colored and clearcoated. Topcoating in this case requires high heat deformation resistance, which is a requirement met by only a few plastics. Mass coloring, especially with effect pigments, is very costly and in many cases lessens the mechanical properties of the substrate.

Instead of spray painting it is possible to use other coating processes, such as the backmolding technology. Here, paint films are produced by roller coating or gravure printing processes and are injection or compression backmolded with carrier materials.

J. H. Schut in Plastics World, July 1996, pages 48 to 52 describes the application of such paint films in the production of automobile parts. Polyvinylidene fluoride films and polyvinyl fluoride films are described which are used in conjunction with ABS as substrates. Polyvinylidene fluoride/acrylate films are also mentioned. Thermoplastic olefins, as well, may be used as substrates. Production techniques listed include thermoforming, thermoforming in conjunction with injection molding, and injection molding alone.

To date, all of the known backmolding films have found application only for effect colorings and multicolor decorations, since the films are very costly.

Another known bodywork material comprises coextruded sheets of polymethyl methacrylate (PMMA) and ABS. For example, H. Kappacher, in Kunststoffe 86 (1996), 388 to 392, describes coextruded PMMA/ABS composite sheets. The bodywork parts are, produced by coextrusion through a slot die to form sheets, which are subsequently thermoformed. In some applications, however, the thermal aging resistance of the ABS is inadequate. To protect the ABS or ABS/PC against UV light it is necessary to use relatively thick UV-absorbing PMMA top layers. The impact strength may also be inadequate, lessened as it is by the brittle PMMA top layer. Furthermore, the surface gloss decreases sharply at draw ratios of 1:2 and above.

One backmolding process for producing colored plastic moldings is offered under the name of Paintless Film Molding—PFM-System®. This represents a cooperative venture between BASF AG, Engel GmbH, Röhm GmbH and Senoplast GmbH & Co. KG. An overview of coextruded films is given in Kunststoffe 89 (1999, 3, pages 96 to 101).

Composite laminated films are described, for example, in DE-A-196 51 350.

When thermoplastics are used as exterior bodywork parts of large surface area (wings, exterior door panels, etc.) the requirement is ductile, i.e. splinterless fracture (even at low temperatures) in combination with a very low linear coefficient of thermal expansion (CTE). Moreover, the components ought to remain undamaged on impacts up to a speed of from 5 to 8 km/h (dubbed the minor damage limit). In this field of use, at the present time, materials such as unreinforced PBT/PC or PPE/PA blends are occasionally used. The coefficient of linear thermal expansion (CTE) of these materials (more than 80*10⁻⁶ 1/K), much higher than that of steel (12*10⁻⁶ 1/K) and aluminum (23*10⁻⁶ 1/K), must be compensated by appropriate constructional measures (Hopfenspirger et al. in Kunststoffe 88 (1998) 10, pages 1878 to 1886). In addition, ASA/PC blends have been developed, which as amorphous materials have a somewhat lower CTE than PBT/PC or PPE/PA blends.

Unreinforced thermoplastics therefore have markedly higher coefficients of linear expansion than steel and aluminum. Through the use of mineral fillers in small proportions it has been possible to achieve values no lower than about 60*10⁻⁶ 1/K. Higher filler contents, in contrast, led to an unacceptable impairment of the low temperature impact strength of the blend.

Although it was possible to attain values below 60*10⁻⁶ 1/K using fiber-reinforced thermoplastics, their brittle fracture properties meant that such products could not be used to date for this application. For instance, a head-on impact test on a trunk lid made from a PBT/ASA blend reinforced with 15% glass fiber at a temperature of −30° C. and a speed of 32 km/h results in a splintering fracture in which the component breaks up into a number of large pieces. Moreover, at high fiber contents and/or fiber lengths, paintability is restricted. A class A surface can be achieved only following pretreatment.

It is an object of the present invention to provide backmolded plastic moldings which after backmolding give class A “painted” components exhibiting advantageous fracture properties.

We have found that this object is achieved by a backmolded polymer molding comprising a polymer backmolding film backmolded by injection molding or casting with a fiber reinforced plastic having a fiber content of from 5 to 30% by weight, the film preferably having a thickness of from 0.5 to 1.0 mm and the backmolding material preferably having a thickness of from 1.5 to 4.5 mm, it being possible for up to 50% by weight of the fibers to have been replaced by mineral fillers. In accordance with one embodiment, none of the fiber is replaced.

It has been found in accordance with the invention that the surface of the resulting backmolded plastic moldings is not adversely affected by the use of fiber-reinforced products. It has also been found that the fracture properties of the fiber reinforced materials are strongly positively influenced by the backmolding film.

In particular, the combination of glass fiber reinforced thermoplastics as backmolding material with a film made of unreinforced thermoplastics makes it possible for the first time to produce class A components which are produced without painting.

The plastic moldings of the invention are of better penetration resistance and/or low-temperature impact strength than the known moldings while being at the same time of very low linear thermal expansion. They are therefore particularly suitable for exterior use, where they are protected by the film against UV radiation and the effects of weather. Use in the automotive sector is particularly appropriate.

The individual layers and components of the backmolded moldings or backmolding films are described below.

Layer (1′)

Layer (1′) is composed of the following components A and B and, if used, C, which total to 100% by weight.

Component A is a graft copolymer of
a1 1-99% by weight, preferably 55-80% by weight, in particular 55-65% by weight, of a particulate graft base A1 having a glass transition temperature of below 0° C.,
a2 1-99% by weight, preferably 20-45% by weight, in particular 35-45% by weight, of a graft A2 comprising the following monomers, based on A2,
a21 40-100% by weight, preferably 65-85% by weight, of units of styrene, a substituted styrene or a (meth)acrylate or mixtures thereof, especially of styrene and/or α-methylstyrene, as component A21, and
a22 up to 60% by weight, preferably 15-35% by weight, of units of acrylonitrile or methacrylonitrile, especially acrylonitrile, as component A22.

The graft A2 here consists of at least one graft shell, the graft copolymer A overall having a mean particle size of 50-1000 nm.

Component A1 consists of the following monomers:
a11 80-99.99% by weight, preferably 95-99.9% by weight, of at least one C₁₋₈ alkyl ester of acrylic acid, preferably n-butyl acrylate and/or ethylhexyl acrylate, as component A11,
a12 0.01-20% by weight, preferably 0.1-5.0% by weight, of at least one polyfunctional crosslinking monomer, preferably diallyl phthalate and/or DCPA, as component A12.

In one embodiment of the invention the mean particle size of component A is 50-800 nm, preferably 50-600 nm.

In another inventive embodiment the particle-size distribution of component A is bimodal, 60-90% by weight of the particles having a mean size of 50-200 nm and 10-40% by weight having a mean size of 50-400 nm, based on the overall weight of component A.

The mean particle size and particle-size distribution indicated comprise the figures determined from the integral mass distribution. In the case of the mean particle sizes according to the invention the figure is in all cases the weight-average particle size as determined by means of an analytical ultracentrifuge in accordance with the method of W. Scholtan and H. Lange, Kolloid-Z. und Z.-Polymere 250 (1972), 782-796. The ultracentrifuge measurement gives the integral mass distribution of the particle diameter of a sample. From this it is possible to derive what percentage of the particles, by weight, has a diameter equal to or less than a certain size. The mean particle diameter, also referred to as the d₅₀ value of the integral mass distribution, is defined as that particle diameter below which lie 50% by weight of the particles. At that point, 50% by weight of the particles also have a greater diameter than the d₅₀ value. The breadth of the particle-size distribution of the rubber particles is characterized using not only the d₅₀ value (mean particle diameter) but also the d₁₀ and d₉₀ values resulting from the integral mass distribution. The d₁₀ and d₉₀ values of the integral mass distribution are defined as for the d₅₀ value with the difference that they are related to 10 and 90% by weight, respectively, of the particles. The quotient

$$\frac{{ⅆ}_{90} - {ⅆ}_{10}}{{ⅆ}_{50}} = Q$$

is a measure of the breadth of distribution (scatter) of the particle size. For emulsion polymers A which can be used in accordance with the invention as component A, Q is preferably less than 0.5, in particular less than 0.35.

The acrylate rubbers A1 are preferably alkyl acrylate rubbers comprising one or more C₁₋₈ alkyl acrylates, preferably C₄₋₈ alkyl acrylates, using preferably—at least in part—butyl, hexyl, octyl or 2-ethylhexyl acrylate, especially n-butyl and 2-ethylhexyl acrylate. Up to 30% by weight of these alkyl acrylate rubbers can contain, in copolymerized form, monomers which form hard polymers, such as vinyl acetate, (meth)acrylonitrile, styrene, substituted styrene, methyl methacrylate and vinyl ethers.

The acrylate rubbers additionally include 0.01-20% by weight, preferably 0.1-5% by weight, of polyfunctional monomers having a crosslinking action (crosslinking monomers). Examples thereof are monomers containing 2 or more copolymerizable double bonds, which are preferably not 1,3-conjugated.

Examples of suitable crosslinking monomers are divinylbenzene, diallyl maleate, diallyl fumarate, diallyl phthalate, diethyl phthalate, triallyl cyanurate, triallyl isocyanurate, tricyclodecenyl acrylate, dihydrodicyclopentadienyl acrylate, triallyl phosphate, allyl acrylate and allyl methacrylate. A crosslinking monomer which has proven particularly favorable is dicyclopentadienyl acrylate (DCPA; cf. DE-C 12 60 135).

Component A is a graft copolymer. The graft copolymers A have a mean particle size d₅₀ of 50-1000 nm, preferably 50-800 nm and, with particular preference, 50-600 nm. Such particle sizes can be obtained by using a graft base A1 of this component A having particle sizes of 50-350 nm, preferably 50-300 nm and, with particular preference, 50-250 nm.

The graft copolymer A is generally a single-stage or multistage polymer, i.e., a polymer composed of a core and of one or more shells. The polymer consists of a base stage (graft core) A1 and of one or—preferably—more stages A2 (graft) grafted thereon, called the graft stages or graft shells.

By single grafting or multiple, stepwise grafting it is possible to apply one or more graft shells to the rubber particles, it being possible for each graft shell to have a different composition. In addition to the grafting monomers, polyfunctional crosslinking monomers or monomers containing reactive groups can also be grafted on (see, for example, EP-A-0 230 282, DE-A 36 01 419, EP-A-0 269 861).

In one preferred embodiment, component A consists of a multistage graft copolymer, the graft stages being produced generally from resin-forming monomers and having a glass transition temperature T_{g} of more than 30° C., preferably more than 50° C. The purpose of the multistage structure is, inter alia, to obtain (partial) compatibility of the rubber particles A with the thermoplastic B.

Graft copolymers A are produced, for example, by grafting at least one of the monomers A2 listed below onto at least one of the graft bases or graft core materials A1 listed above.

According to one embodiment of the invention, the graft base A1 is composed of 15-99% by weight of acrylate rubber, 0.1-5% by weight of crosslinker and 0-49.9% by weight of one of the other monomers or rubbers indicated.

Monomers suitable for forming the graft A2 are styrene, α-methylstyrene, (meth)acrylates, acrylonitrile and methacrylonitrile, especially acrylonitrile.

According to one embodiment of the invention, crosslinked acrylate polymers having a glass transition temperature of below 0° C. are used as the graft base A1. The cross-linked acrylate polymers should preferably have a glass transition temperature of below −20° C., in particular below −30° C.

In one preferred embodiment the graft A2 consists of at least one graft shell and the outermost graft shell thereof has a glass transition temperature of more than 30° C., where a polymer formed from the monomers of the graft base A2 would have a glass transition temperature of more than 80° C.

Suitable production processes for graft copolymers A are emulsion, solution, bulk or suspension polymerization. The graft copolymers A are preferably produced by free-radical emulsion polymerization in the presence of latices of component A1 at temperatures of 20° C.-90° C. using water-soluble or oil-soluble initiators, such as peroxodisulfate or benzyl peroxide, or with the aid of redox initiators. Redox initiators are also suitable for polymerization below 20° C.

Appropriate emulsion polymerization processes are described in DE-A 28 26 925, 31 49 358 and in DE-C 12 60 135.

The synthesis of the graft shells takes place preferably by the emulsion polymerization process, as is described in DE-A 32 27 555, 31 49 357, 31 49 358, 34 14 118. Defined setting of the particle sizes of 50-1000 nm according to the invention is preferably effected in accordance with the processes described in DE-C 12 60 135 and DE-A 28 26 925, or Applied Polymer Science, Volume 9 (1965), page 2929. The use of polymers having different particle sizes is known, for example, from DE-A 28 26 925 and U.S. Pat. No. 5,196,480.

According to the process described in DE-C 12 60 135 the graft base A1 is first of all produced by polymerizing the acrylate or acrylates used in accordance with one embodiment of the invention and the polyfunctional, crosslinking monomer, alone or together with the other comonomers, in an aqueous emulsion in a manner known per se at from 20 to 100° C., preferably from 50 to 80° C. The customary emulsifiers can be used, for example alkali metal salts of alkyl- or alkylarylsulfonic acids, alkyl sulfates, fatty alcohol sulfonates, salts of higher fatty acids having 10 to 30 carbons, or resin soaps. Use is preferably made of the sodium salts of alkylsulfonates or fatty acids of 10 to 18 carbons. In one embodiment the emulsifiers are employed in amounts of 0.5-5% by weight, in particular 1-2% by weight, based on the monomers that are employed for producing the graft base A1. It is usual to operate with a weight ratio of water to monomers of from 2:1 to 0.7:1. Polymerization initiators used are, in particular, the customary persulfates, such as potassium persulfate. It is also possible, however, to employ redox systems. The initiators are generally employed in amounts of 0.1-1% by weight, based on the monomers that are employed in producing the graft base A1. Further polymerization auxiliaries used in the polymerization can be the customary buffer substances by means of which pH values of preferably 6-9 are set, such as sodium bicarbonate and sodium pyrophosphate, and also 0-3% by weight of a molecular weight regulator, such as mercaptans, terpinols or dimeric α-methylstyrene.

The precise polymerization conditions, especially the nature, rate of addition and amount of the emulsifier, are determined within the ranges set out above and specifically in such a way that the resulting latex of the crosslinked acrylate polymer has a d₅₀ value in the range of about 50-1000 nm, preferably 50-600 nm, and, with particular preference, in the range of 80-500 nm. The particle-size distribution of the latex should preferably be narrow.

Then, to produce the graft polymer A, according to one embodiment of the invention a monomer mixture of styrene and acrylonitrile is polymerized in a subsequent step in the presence of the resultant latex of the crosslinked acrylate polymer, the weight ratio of styrene to acrylonitrile in the monomer mixture being—in accordance with one embodiment of the invention—in the range from 100:0 to 40:60, preferably in the range from 65:35 to 85:15. It is advantageous to carry out this graft copolymerization of styrene and acrylonitrile onto the crosslinked polyacrylate polymer, used as graft base, again in aqueous emulsion under the customary conditions described above. The graft copolymerization can appropriately be effected in the same system as the emulsion polymerization for producing the graft base A1, with the possible addition if required of further emulsifier and initiator. The monomer mixture of styrene and acrylonitrile which is to be engrafted in accordance with one embodiment of the invention can be added to the reaction mixture all at once, in stages in a number of portions or, preferably, continuously during the polymerization. The graft copolymerization of the mixture of styrene and acrylonitrile in the presence of the crosslinking acrylate polymer is conducted so as to give a degree of grafting of 1-99% by weight, preferably 20-45% by weight, especially 35-45% by weight, based on the overall weight of component A, in the graft copolymer A. Since the grafting yield in the graft copolymerization is not 100%, it is necessary in the graft copolymerization to employ a somewhat larger amount of the monomer mixture of styrene and acrylonitrile than that corresponding to the desired degree of grafting. Control of the grafting yield in graft copolymerization and thus of the degree of grafting of the finished graft copolymer A is familiar to the skilled worker and can be effected by way, inter alia, of the metering rate of the monomers or the addition of regulator (Chauvel, Daniel, ACS Polymer Preprints 15 (1974), page 329 ff.). The emulsion graft copolymerization generally produces about 5-15% by weight, based on the graft copolymer, of free, ungrafted styrene-acrylonitrile copolymer. The fraction of the graft copolymer A in the polymerization product obtained in the graft copolymerization is determined in accordance with the method indicated above.

In the case of the production of graft copolymers A by the emulsion process, in addition to the given process advantages, reproducible changes in particle size are also possible, for example by at least partial agglomeration of the particles to form larger particles. This means that in the graft copolymers A it is also possible for there to be polymers having different particle sizes.

In particular, component A comprising graft base and graft shell(s) can be optimized for the particular intended application, especially in terms of the particle size.

The graft copolymers A generally contain 1-99% by weight, preferably 55-80 and, with particular preference, 55-65% by weight of graft base A1 and 1-99% by weight, preferably 20-45 and, with particular preference, 35-45% by weight of the graft A2, based in each case on the graft copolymer as a whole.

Component B

Component B is a copolymer of
b1 40-100% by weight, preferably 60-85% by weight, of units of styrene, a substituted styrene or a (meth)acrylate or mixtures thereof, especially of styrene and/or a-methylstyrene, as component B1,
b2 up to 60% by weight, preferably 15-40% by weight, of units of acrylonitrile or methacrylonitrile, especially of acrylonitrile, as component B2.

In accordance with a preferred embodiment of the invention, the viscosity number of component B is 50-90, preferably 60-80.

Component B is preferably an amorphous polymer as described above as graft A2. In one embodiment of the invention a copolymer of styrene and/or a-methylstyrene with acrylonitrile is used as component B. The acrylonitrile content of these component B copolymers is 0-60% by weight, preferably 15-40% by weight, based on the overall weight of component B. Component B also embraces the free, ungrafted styrene-acrylonitrile copolymers that are formed in the course of the graft copolymerization for producing component A. Depending on the conditions chosen for the graft copolymerization for producing the graft copolymer A it may be possible for a sufficient amount of component B to be formed during the graft copolymerization itself. In general, however, it will be necessary to blend the products obtained in the graft copolymerization with additional, separately produced component B.

This additional, separately produced component B can preferably be a styrene-acrylonitrile copolymer, an α-methylstyrene-acrylonitrile copolymer or an α-methyl-styrene-styrene-acrylonitrile terpolymer. These copolymers can be employed individually or else as a mixture for component B, so that the additional, separately produced component B may, for example, comprise a mixture of a styrene-acrylonitrile copolymer and of an α-methylstyrene-acrylonitrile copolymer. Where component B consists of a mixture of a styrene-acrylonitrile copolymer and of an α-methylstyrene-acrylonitrile copolymer, the acrylonitrile contents of the two copolymers preferably should not differ by more than 10% by weight, particularly preferably not by more than 5% by weight, based on the overall weight of the copolymer. Component B may, however, alternatively consist of only one single styrene-acrylonitrile copolymer, if the same monomer mixture of styrene and acrylonitrile was used as the starting material in the graft copolymerizations for producing component A and in the production of the additional, separately produced component B.

The additional, separately produced component B can be obtained by the conventional processes. Thus, according to one embodiment of the invention, the styrene and/or α-methylstyrene can be copolymerized with the acrylonitrile in bulk, solution, suspension or aqueous emulsion. Component B preferably has a viscosity number of from 40 to 100, more preferably from 50 to 90 and in particular from 60 to 80. This viscosity number is determined in accordance with DIN 53 726, dissolving 0.5 g of material in 100 ml of dimethylformamide.

The mixing of components A and B and, if used, C can be performed in any desired manner by any known process. If components A and B have been produced, for example, by emulsion polymerization it is possible to mix the resulting polymer dispersions with one another, then to coprecipitate the polymers and to work up the polymer mixture. Preferably, however, the blending of components A and B is done by conjoint extrusion, kneading or rolling of the components, the latter having been isolated if necessary beforehand from the aqueous dispersion or solution obtained in the polymerization. The graft copolymerization products (component A) obtained in aqueous dispersion can also be only partially dewatered and can be mixed in the form of moist crumbs with component B, complete drying of the graft copolymers then taking place in the course of mixing.

In one preferred embodiment component (1) comprises, in addition to components A and B, additional components C, with or without other additives, as described below.

Component C

Suitable polycarbonates C are known per se. They preferably have a molecular weight (weight mean value M_{w}, determined by gel permeation chromatography in tetrahydrofuran against polystyrene standards) in the range from 10,000 to 60,000 g/mol. They are obtainable, for example, by the processes of DE-B-1 300 266 by interfacial polycondensation or by the process of DE-A-1 495 730 by reacting diphenyl carbonate with bisphenols. A preferred bisphenol is 2,2-di(4-hydroxyphenyl)propane, which is referred to generally—and below—as bisphenol A.

Instead of bisphenol A it is also possible to use other aromatic dihydroxy compounds, especially 2,2-di(4-hydroxyphenyl)pentane, 2,6-dihydroxynaphthalene, 4,4′-xydiphenyl sulfone, 4,4′-dihydroxydiphenyl ether, 4,4′-dihydroxydiphenyl sulfide, 4,4′-dihydroxydiphenylmethane, 1,1-di(4-hydroxyphenyl)ethane, 4,4′-dihydroxy-biphenyl or dihydroxydiphenylcycloalkanes, preferably dihydroxydiphenylcyclohexanes or dihydroxylcyclopentanes, especially 1,1-bis(4-hydroxyphenyl)-3,3,5-trimethylcyclohexane, and also mixtures of the abovementioned dihydroxy compounds.

Particularly preferred polycarbonates are those based on bisphenol A or on bisphenol A together with up to 80 mol % of the abovementioned aromatic dihydroxy compounds.

It is also possible to use copolycarbonates according to U.S. Pat. No. 3,737,409; of particular interest in this context are copolycarbonates based on bisphenol A and di(3,5-dimethyldihydroxyphenyl) sulfone, which are notable for high heat deformation resistance. It is also possible to employ mixtures of different polycarbonates.

The average molecular weights (weight mean value M_{w}, determined by gel permeation chromatography in tetrahydrofuran against polystyrene standards) of the polycarbonates C are, in accordance with the invention, in the range from 10,000 to 64,000 g/mol. They are preferably in the range from 15,000 to 63,000, in particular in the range from 15,000 to 60,000 g/mol. This means that the polycarbonates C have relative solution viscosities in the range from 1.1 to 1.3, measured in 0.5% strength by weight solution in dichloromethane at 25° C., preferably from 1.15 to 1.33. The relative solution viscosities of the polycarbonates employed preferably differ by not more than 0.05, in particular not more than 0.04.

The polycarbonates C can be employed either in ground or in granulated form. As component C they are present in amounts of 0-50% by weight, preferably of 10-40% by weight, based in each case on the overall molding composition.

The addition of polycarbonates leads inter alia to greater thermal stability and improved crack resistance of the sheets, films and moldings.

The component (1′) used in accordance with the invention may, furthermore, include further additives which are customary and typical for polycarbonates, SAN polymers and graft copolymers or mixtures thereof. Examples which may be mentioned of such additives are dyes, pigments, effect colorants, antistatics, antioxidants, stabilizers for enhancing the thermal stability, for increasing the light stability, for raising the resistance to hydrolysis and the chemical resistance, heat stabilizers, and especially the lubricants that are appropriate for the production of shaped articles and moldings. The addition of these further additives can take place at any stage in the production process, but they are preferably added early on so as to benefit from early exploitation of the stabilizing effects (or other special effects) of the additive. Heat stabilizers and antioxidants are usually metal halides (chlorides, bromides, iodides) derived from metals of group I of the Periodic Table of the Elements (such as Li, Na, K, Cu).

Appropriate stabilizers are the customary hindered phenols, but also vitamin E and compounds of analogous structure. Also suitable are HALS (hindered amine light stabilizers), benzophenones, resorcinols, salicylates, benzotriazoles such as Tinuvin® P (UV absorber 2-(2H-benzotriazol-2-yl)-4-methylphenol from CIBA) and other compounds. They are usually used in amounts of up to 2% by weight (based on the overall mixture).

Suitable lubricants and mold release agents are stearic acids, stearyl alcohol, stearic esters and, generally, higher fatty acids, their derivatives and corresponding fatty acid mixtures having 12-30 carbon atoms. The amounts of these additives are in the range 0.05-1% by weight.

Other suitable additives are silicone oils, oligomeric isobutylene or similar substances, with customary amounts being 0.05-5% by weight. It is likewise possible to use pigments, dyes, optical brighteners, effect colorants, such as titanium dioxide, carbon black, iron oxides, phthalocyanines, quinacridones, perylenes, anthraquinones, and aluminum flakes.

Processing aids and stabilizers such as UV stabilizers, lubricants and antistatics are commonly used in amounts of 0.01-5% by weight.

Component (1′) can be produced by processes known per se, by mixing the components. It may be advantageous to premix certain components. Also possible is the mixing of the components in solution and removal of the solvents.

Examples of suitable organic solvents are chlorobenzene, mixtures of chlorobenzene and methylene chloride or mixtures of chlorobenzene or aromatic hydrocarbons, for example toluene.

The solvent mixtures can be evaporated, for example, in evaporative extruders.

The dry components, for example, can be mixed by any known method. Mixing is preferably effected, however, by conjoint extrusion, kneading or rolling of the components, preferably at 180-400° C., the components having been isolated beforehand if necessary from the solution obtained during the polymerization or from the aqueous dispersion.

In this context, the components can be added together or separately/in succession.

The layer (1′) may also be composed of ABS, polycarbonate, polybutylene terephthalate (PBT), polyethylene terephthalate, polyamide, polyetherimide (PEI), polyether ketone (PEK), polyphenylene sulfide (PPS), polyphenylene ether, or blends. The individual materials are known, for example, from H. Domininghaus, Die Kunststoffe und ihre Eigenschaften, VDI-Verlag, Düsseldorf (1992). The substrate layer preferably comprises a molding composition of component (1), ABS, polycarbonate, polybutylene terephthalate, polyethylene terephthalate, polyamide or blends thereof. It may also consist wholly or substantially of these polymers. With particular preference, the substrate layer (1′) comprises a molding composition of component (1), ABS, polycarbonate or polybutylene terephthalate, especially a molding composition of component (1). It may also consist wholly or essentially of these polymers.

The layer thickness is preferably from 100 to 1 000 μm, in particular from 200 to 500 μm.

Layer (2′)

Layer (2′) is a color backing layer or interlayer which is composed of toughened PMMA, polycarbonate or the above-described component (1) and which contains no polycarbonate if the substrate layer (1′) contains polycarbonate. If both substrate layer and interlayer either contain polycarbonate or are polycarbonate-free, then a two-layer structure is present.

Toughened PMMA (high-impact PMMA: HI-PMMA) is a polymethyl methacrylate which has been made impact-resistant by means of suitable additives. Suitable impact-modified PMMAs are described, for example, by M. Stickler, T. Rhein in Ullmann's encyclopedia of industrial chemistry Vol. A21, pages 473-486, VCH Publishers Weinheim, 1992, and by H. Domininghaus, Die Kunststoffe und ihre Eigenschaften, VDI-Verlag Düsseldorf, 1992. The interlayer (2) or the layer (2′) can comprise effect colorants. These are, for example, dyes, metal flakes or pigments. The dyes or pigments can be organic or inorganic compounds.

The composite laminated films may also comprise
(2″) an interlayer of polymethyl methacrylate, high-impact polymethyl methacrylate, ABS, polycarbonate, polyethylene terephthalate, styrene-acrylonitrile copolymers, polyamide, polyether sulfone or polysulfone, which comprises effect colorants,
having a layer thickness of from 50 to 400, preferably from 100 to 300, μm.
   Layer (3)

Layer (3) of the backmolding films can be a top layer of PMMA. The PMMA used preferably has a number-average molecular weight of from 40,000 to 100,000. Examples of suitable PMMA molding compositions are Lucryl® G88 or G87 from Resart/BASF, and also the compositions described in EP-A-0 225 500.

The layer thickness of the above backmolding films is preferably from 100 μm to 0.5 mm.

Instead of polymethyl methacrylate the transparent top layer (3′) may comprise high-impact polymethyl methacrylate, PVDF, ABS, polycarbonate, polyethylene terephthalate or styrene-acrylonitrile copolymers. In particular it comprises polymethyl methacrylate, high-impact polymethyl methacrylate or polycarbonate, especially polymethyl methacrylate or high-impact polymethyl methacrylate, PVDF. It may also consist wholly or essentially of these polymers. The polymers are chosen so as to give a transparent top layer.

A tie layer comprising an adhesion promoter with a layer thickness of from 5 to 100 μm may be present on the outer face of the substrate layer. The purpose of the adhesion promoter is to produce a firm bond with a chosen substrate that comes to lie under the substrate layer (as a result of backmolding, for example). The tie layer is used when the adhesion of this further substrate to the substrate layer is inadequate (as in the case of polyolefin substrates, for example). The adhesion promoter used is an adhesion promoter commonly used for this combination of materials. Examples of suitable adhesion promoters are:
ethylene-vinyl acetate copolymers for coupling to polyethylene and maleic anhydride grafted polypropylenes for coupling to polypropylene. In both cases, adhesion is achieved by the introduction of polar groups into the nonpolar polyolefins.

Backmolding films comprising a substrate layer (1′), if desired an interlayer (2′), a top layer (3′), and, if desired, a tie layer (0) preferably have the following layer thicknesses:
substrate layer (1′) from 90 to 990 μm; interlayer (2″) from 50 to 400 μm; top layer (3′) from 10 to 100 μm; tie layer (0) from 5 to 100 μm. The overall thickness of the composite laminated film is from 100 to 1000 μm, preferably from 200 to 800 μm.

The three-layer film can be produced, for example, from a composite layer film having 2 layers (2′) and (3′) by providing it with a substrate layer (1′). Production can be in accordance with the process described below. For this purpose it is advantageous for the ratio of the MFI (melt flow index) values of the individual components of the composite laminated films to be not more than 3:1, particularly preferably not more than 2:1. Consequently, the greatest MFI value of one of the components (0), (1′), (2′), (3′), where present in the respective laminated films, is not more than three times, with particular preference not more than two times, the lowest MFI value. This ensures uniform flow properties of all of the components used in the composite laminated sheets or films. This harmonized flow behavior is particularly advantageous in the context of the production processes described below.

Processes for Producing the Backmolding Films

The backmolding films can be produced by adapter coextrusion or die coextrusion of the components, with the overall composite being produced preferably in a single-stage process. Die coextrusion, especially when utilizing the “diaphragm die” technology, has the advantage of allowing greater orientation of the metal flakes and hence the appearance of a metallic paint.

The individual components are rendered flowable in extruders and are brought into contact with one another by means of special equipment so as to give the composite laminated sheets or films having the layer sequence described above. For example, the components can be coextruded through a slot die. This process is elucidated in EP-A-0 225 500.

In addition, they can be produced by the adapter coextrusion process as described in the conference volume of the technical conference on extrusion technology “Coextrusion von Folien”, Oct. 8/9, 1996, VDI-Verlag Düsseldorf, in particular the paper by Dr. Netze. This economic process is employed for the majority of coextrusion applications.

Furthermore, the backmolding films can be produced by laminating films or sheets of the components onto one another within a heatable nip. In this case, films of the individual components are produced first of all. This can be done by known processes. The desired layer sequence is then produced by laying the films over one another appropriately to form an assembly which is then passed through a heatable roll nip and laminated under the action of pressure and heat to form a laminated sheet or film.

Especially in the case of the adapter coextrusion process, harmonizing the flow properties of the individual components is advantageous for the development of uniform layers.

Moldings, especially motor vehicle parts such as wings, door panels, bumpers, spoilers, and exterior mirrors, can be produced by known processes from the backmolding films. For example, composite laminated sheets having the three-layer structure of substrate layer, interlayer and top layer or the two-layer structure of substrate layer and top layer can be produced by thermoforming, using either positive or negative thermoforming processes. Appropriate processes are known to the skilled worker. In such processes, the composite laminated sheets according to the invention are stretched or drawn. Since the gloss and the surface quality of the laminated sheets according to the invention does not decrease on stretching at high draw ratios, for example up to 1:5, there are virtually no restrictions of practical relevance on the thermoforming processes in respect of the stretching possible.

Moldings may be produced from the backmolding films by injection backmolding or casting behind the composition laminated films with a fiber reinforced plastic, especially with component (1′), preferably ABS, PBT, PC/ASA, PC/PBT, PBT/ASA or else PP or PE (when using a tie layer), it being possible for the backmolding film to be thermoformed beforehand.

Production takes place preferably by producing the backmolding film by adapter coextusion or die coextrusion of the respective components (1′) and/or (2′) and/or (3′), the entire composite being produced in a single-stage process,
thermoforming the backmolding film in a mold, and
injection backmolding or casting behind the backmolding film with the fiber reinforced plastic, the fibers being introduced directly during processing so that their length in the component is at least partly >1 mm.

The fiber reinforced plastic comprises fibers in an amount of from 5 to 30% by weight, preferably from 7 to 25% by weight, in particular from 10 to 20% by weight.

The fibers may be natural fibers such as flax, hemp, jute, sisal, ramie or kenaf, or, preferably, carbon fibers or glass fibers.

The glass fibers used may be made of E, A or C glass and are preferably furnished with a size and an adhesion promoter. Their diameter is generally between 6 and 20 μm. Both continuous fibers (rovings) and cut glass fibers (staple) having a length of from 1 to 15 mm, preferably from 5 to 10 mm, may be used, and are introduced directly into the processing machine.

In injection molding, granules having a relatively low fiber length of less than 1 mm are used.

The moldings come from the automotive sector; in particular, they are exterior automotive bodywork parts. The parts in question may be relatively small parts, such as mirrors or trim, or else may be of large surface area, examples being wings, hoods, covers, doors, and so on. They may also be bumpers. In this case, backmolding with polyurethane in particular may lead, for example, to bumpers which have very good impact damping properties.

The moldings are useful generally throughout the automotive sector.

The moldings according to the invention, especially in relation to moldings in which an unreinforced ABS substrate layer is used, have the following advantages:
little effect on toughness by the hard and brittle PMMA top layer when the substrate layer according to the invention (component 1) is used, especially when using fiber reinforced backmolding material
increased scratch resistance of the PMMA layer, which is also influenced by the substrate layer lying below the top layer
effective prevention of the formation of cracks in the PMMA top layer as a result of the toughened interlayer and/or toughened substrate layer
thinner PMMA top layers can be used without reducing the UV stability of the substrate layer
the moldings have very good properties in respect of low-temperature impact strength, elongation at break, and surface gloss
the composite laminated sheets or films can be thermoformed with retention of gloss even at very high draw ratios (especially in the positive thermoforming process)
cost-effective coloring is possible by coloring the thin interlayer
depth (flop) effects can be produced in the interlayer, especially when it comprises HI-PMMA or polycarbonate
cost-effective production by the adapter coextrusion process is possible, especially when the components selected have similar flow properties
even highly viscous and scratch resistant PMMA grades can be coextruded with other highly viscous components
moldings comprising polycarbonates in the substrate layer are highly resistant to thermal deformation and, in particular, are impact resistant
no solvents are used when coloring with the composite laminated films.

The surface of the moldings of the invention is unaffected by the use of fiber reinforced products. It has been shown, for example, that even long glass fiber reinforced products produced by the process known as LFT compression molding and comprising, for example, ASA/PC blends (fiber length in the component: about 5 mm) have a flawless surface. On the side not coated with the film, in contrast, the fibers are clearly evident.

In mechanical investigations (head-on impact test) on backmolded trunk lids produced with short glass fiber reinforced PBT/ASA and long fiber reinforced ASA/PC by melt application compression molding, it was found that the fracture properties of the fiber reinforced materials are strongly positively influenced by the film. The combination of glass fiber reinforced thermoplastics as backmolding material (thickness preferably from 2 to 3 mm) with a backmolding film made from unreinforced thermoplastics (thickness preferably from 0.5 to 1.5 mm) makes it possible to produce class A components which are produced without painting and which have a modulus of elasticity of more than 5000 N/mm², a linear thermal expansion of less than 60 10e-6 1/K, and a fracture pattern which is splinteriess over wide ranges. Indeed, the fracture pattern following a head-on impact test at −30° C. is more favorable than when using an unreinforced thermoplastic.

The invention is illustrated in more detail below with reference to examples.

The backmolding film used was a three layer composite of HI-PMMA/colored HI-PMMA/ASA/colored PC, 1 mm thick. Additionally, ASA/PC blends or PBT/ASA blends were used as backmolding material.

The ASA/PC blend had the following composition:
60% PC, 30% component (1)
10% adjuvants
The PBT/ASA blend had the following composition:
50% PBT, 30% component (1)
15% glass fiber (<1 mm)
5% adjuvants

Polybutylene terephthalate having a viscosity number of 130 was used.

The glass fibers used were cut glass fibers having a diameter of 15 μm and a length of 12 mm, and were mixed directly into the ASA/PC.

Tests were conducted to determine both the minor damage limit (no damage evident) and the fracture properties at a collision speed of 32 km/h. The results are collected in the table below.

| | Minor damage | Fracture properties |
|---|---|---|
| Backmolding | limit [km/h] at | at 32 km/h and |
| material | 23° C./−30° C. | 23° C./−30° C. |
| ASA/PC, | 24.8/13.1 | White fracture on film/ |
| unreinforced | | splintering with two |
| | | large fragments |
| ASA/PC, 15% long | in each case ≧ 32.8 | ?/no failure |
| glass fiber | | |
| reinforced | | |
| PBT/ASA, | 5.2/2.5 | Crack along handle/ |
| 15% GF no film | | splintering with three |
| | | large fragments |
| PBT/ASA, 15% GF | 13.1/10.4 | Crack along handle/fairly |
| | | small splinters in the |
| | | collision area |

The backmolding film used was a three layer film. The substrate layer, with a thickness of 800 μm, was composed of ASA/PC. A colored, 100 μm layer of high impact PMMA was used as the middle color layer. The top layer used was a 100 μm layer of high impact PPA. The total thickness of the backmolded molding was 3.2 mm.

1-17. (canceled)

18. A back-molded plastic molding comprising a polymer backmolding film present on a back-molded fiber reinforced plastic,
wherein the plastic molding is obtained by injection backmolding the fiber reinforced plastic having a fiber content of from 5 to 30%, onto the back-molding film,
wherein the back-molded fiber reinforced plastic has a thickness of from 1.5 to 4.5 mm, wherein up to 50% by weight of the fibers may be mineral fillers, wherein the length of the fibers in the plastic molding is at least partly >1 mm, and wherein the backmolding film is a composite laminated film comprising, in this order:
(1) a substrate layer
comprising an ASA molding composition comprising components A and B, and where appropriate C, whose total amount is 100% by weight,
(a) 1-99% of a graft copolymer of
(a1) 1-99% by weight of a particulate graft A1 comprising the following monomers
(a11) 80-99.99% by weight of at least one C₁₋₁₈ alkyl ester of acrylic acid as component A11,
(a12) 0.01-20% by weight of at least one polyfunctional crosslinking monomer as component A12,
(a2) 1-99% by weight of a graft A2 comprising the following monomers, based on A2,
(a21) 40-100% by weight of units of styrene, a substituted styrene or a (meth)acrylate or mixtures thereof as component A21, and
(a22) up to 60% by weight of units of acrylonitrile or methacrylonitrile as component A22,
the graft A2 here consists of at least one graft shell, the graft copolymer having a mean particle size of 50-1000 nm,
as component A,
(b) 1-99% by weight of a copolymer of
(b1) 40-100% by weight of units of styrene, a substituted styrene or a (meth)acrylate or mixtures thereof as component B1,
(b2) up to 60% by weight of acrylonitrile or methacrylonitrile as component B2, as component B,
(c) 0-80% by weight of polycarbonate as component C,
or a substrate layer comprising polybutylene terephthalate,
(2) if desired, an interlayer of polymethyl methacrylate, high-impact polymethyl methacrylate, ABS, polycarbonate, polyethylene terephthalate, styrene-acrylonitrile copolymers, polyamide, polyether sulfone or polysulfone, which may comprise one or more effect colorants, having a layer thickness of from 50 to 400 μm, and
(3) a transparent top layer comprising at least one styrene-acrylonitrile copolymer, having a layer thickness of from 10 to 100 μm.

19. A plastic molding as claimed in claim 18, wherein the thickness of the substrate layer (1) is from 90 to 990 μm, that of the interlayer (2) from 50 to 400 μm, and that of the top layer (3) from 10 to 100 μm.

20. A plastic molding as claimed in claim 18, wherein the back-molding film on the outer face of the substrate layer comprises a tie layer having a thickness of from 5 to 100 μm and comprising an adhesion promoter.

21. The plastic molding as claimed in claim 18, wherein the fibers are glass fibers.

22. The plastic molding as claimed in claim 18, wherein the polymer backmolding film further comprises an interlayer of at least one of PMMA or high-impact PMMA, which comprises effect colorants.

23. The plastic molding as claimed in claim 18, wherein the fiber reinforced plastic is at least one of a blend of polycarbonate or polybutylene terephthalate with an ASA molding composition.

24. A process for producing an injection backmolded or casting backmolded plastic molding as claimed in claim 18 by
producing the backmolding film by adapter coextrusion or die coextrusion of the respective components (1) and/or (2) and/or (3), the entire composite being produced in a single-stage process, or by laminating films of the components in a heatable nip,
thermoforming the backmolding film in a mold, and injection backmolding or casting behind the backmolding film with the fiber reinforced plastic, wherein in the fibers are introduced directly during processing, so that their length in the component is at least partly >1 mm.

25. A plastic molding comprising a polymer backmolding film which is compression backmolded with a glass fiber reinforced ASA/PC plastic having a fiber content of from 5 to 30% by weight by a melt application or LFT technique, the ASA/PC plastic having a thickness of 1.5 to 4.5 mm, wherein the length of the glass fibers in the glass fiber reinforced plastic in the plastic molding is at least partly >1 mm.

26. A plastic molding comprising a polymer backmolding film which is compression backmolded with a short glass fiber reinforced PBT/ASA plastic having a fiber content of from 5 to 30% by weight by a melt application technique, the PBT/ASA plastic having a thickness of from 1.5 to 4.5 mm.

27. A plastic molding as claimed in claim 25, wherein the film has a thickness of from 0.1 to 1.0 mm.

28. A process for producing a plastic molding as claimed in claim 25 by
producing the backmolding film by adapter coextrusion or die coextrusion of the respective components (1) and/or (2) and/or (3), the entire composite being produced in a single-stage process, or by laminating films of the components in a heatable nip,
thermoforming the backmolding film in a mold, and compression backmolding the backmolding film with the fiber reinforced plastic, wherein the fibers are introduced directly during processing, so that their length in the component is at least partly >1 mm.

29. The plastic molding as claimed in claim 18, which is a paint film.

30. The plastic molding as claimed in claim 29, having a class A finish without painting.

31. The plastic molding as claimed in claim 18, wherein the back-molded fiber reinforced plastic has a thickness of from 2 to 3 mm and the backmolding film has a thickness of from 0.1 to 1.0 mm.
